(19) United States
(12) Patent Application Publication
(10) Pub. No.: US 2010/0125685 A1
(43) Pub. Date: May 20, 2010

(54) STORAGE APPARATUS AND OUTPUT SIGNAL GENERATION CIRCUIT

(75) Inventor: Katsushi Ohta, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/569,532

(22) Filed: Sep. 29, 2009

(30) Foreign Application Priority Data
Nov. 18, 2008 (JP) 2008-294244

(51) Int. Cl. G06F 13/00

(52) U.S. Cl. 710/31

(57) ABSTRACT

According to one embodiment, a storage apparatus configured to connect to other apparatus through a communication interface, includes: a memory device; an analysis object data writing module configured to write, when a predetermined event occurs, analysis object data corresponding to the event in the memory device; a response data generator configured to generate response data corresponding to a request input through the communication interface; and a data output module configured to output the response data through the communication interface when the response data exist, and output the analysis object data stored in the memory device through the communication interface by using a non-transmission time interval of the response data.

### CROSS-REFERENCE TO RELATED APPLICATIONS

This application is based upon and claims the benefit of priority from Japanese Patent Application No. 2008-294244, filed on Nov. 18, 2008, the entire contents of which are incorporated herein by reference.

### BACKGROUND

1. Field

One embodiment of the invention relates to a storage apparatus and output signal generation circuit that transmit data through a communication interface, and more particularly, to a storage apparatus and output signal generation circuit that can transmit internal information.

2. Description of the Related Art

In a computer system, various devices communicate with each other through a communication interface. In such a computer system, a device can acquire various kinds of information such as error information of the devices through the communication interface (refer to, for example, Japanese Patent Application Publication (KOKAI) No. 8-202643 and Japanese Patent Application Publication (KOKAI) No. 2001-216205).

As an example of a connection scheme using the communication interface, there is a scheme in which an external device (hereinafter, referred to as a target device) is connected to a host computer through a high-speed communication interface. Hereinafter, a “host computer” is a computer that uses a target device (“host” in relation to the target device). Therefore, all the communication apparatuses that can use a target device through a communication interface can be the host computer.

As an example of the high-speed communication interface, there are a serial attached small computer system interface (SAS) and a fiber channel (FC) interface. As an example of the target device, there is a storage apparatus such as a hard disk drive. The host computer inputs/outputs data to/from the target device such as a storage apparatus through the communication interface.

The storage apparatus controls various kinds of internal information by using an internal controller. For example, the number of occurrences of reading and writing errors is stored in a memory of the storage apparatus as internal information by the controller. Errors that can be recovered internally within the storage apparatus are stored in the storage apparatus, but the errors are not notified to the host computer. Therefore, the internal information of the storage apparatus is referred to acquire the detailed information including the recovered error information or the like. Accordingly, a highly-advanced operating management of detecting a premonition of a failure of the device can be performed.

The following methods can be considered to acquire the internal information of the storage apparatus for failure analysis or the like. Firstly, a method of directly connecting a specific communication cable (for example, a serial cable) to the device so as to acquire the internal information. Secondly, a method of allowing a host computer to issue an internal information acquisition command through a communication interface. Thirdly, a method of adding required internal information to an inner portion of sense data (error information) or an inner portion of log sense data (for example, SCSI log sense data).

An operation manager of the system can perform a failure analysis based on the internal information of the storage apparatus acquired by using the above methods. However, in any one of the above methods, it is difficult to acquire detailed internal information when the system is in service.

In the case of using the specific communication cable, data access control of a controller in the device stops during the communication. Therefore, during the operation of the system, internal information acquisition cannot be performed by using the communication cable. In the case of allowing the host computer to issue the internal information acquisition command through the communication interface, the internal information acquisition command cannot be issued at a required timing when the device in the system is in operation. In the case of adding the information in an inner portion of the sense data or an inner portion of the log sense data, the amount of information is to be limited due to a sense data standard or a log sense data standard, so that the detailed internal information cannot be acquired. In addition, the internal information can be acquired only at the timing when the sense data is output.

Due to the aforementioned limitations in acquiring the internal information of the device, it takes long time to perform the failure analysis. Particularly, when the failure analysis is performed by a customer, there may be limitations in available tools and in using the host computer. Therefore, the sufficient data used for the failure analysis cannot be collected, and the failure analysis task is difficult to perform.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a system according to any one of embodiments of the invention;

FIG. 2 is an exemplary schematic diagram of a system according to a first embodiment of the invention;

FIG. 3 is an exemplary block diagram of the system having a storage apparatus outputting response data in the first embodiment;

FIG. 4 is an exemplary block diagram of the system having the storage apparatus outputting idle data in the first embodiment;

FIG. 5 is an exemplary block diagram of the system having the storage apparatus outputting analysis object data in the first embodiment;

FIG. 6 is an exemplary block diagram of the storage apparatus in the first embodiment;

FIG. 7 is an exemplary block diagram of an HDC in the first embodiment;

FIG. 8 is an exemplary flowchart of an analysis object data write process of a host MCU in the first embodiment;

FIG. 9 is an exemplary flowchart of an interrupt process in the first embodiment;

FIG. 10 is an exemplary flowchart of a multiplexer process in the first embodiment;

FIG. 11 is an exemplary block diagram of the HDC in details in the first embodiment;

FIG. 12 is an exemplary block diagram of an analysis object data transmission control circuit in the first embodiment;

FIG. 13 is an exemplary schematic diagram of a management terminal in the first embodiment;

FIG. 14 is an exemplary block diagram of the management terminal in the first embodiment;

FIG. 15 is an exemplary flowchart of an analysis object data extraction process in the first embodiment;

FIG. 16 is an exemplary schematic diagram illustrating transmitting data with no analysis object data to be transmitted according to a second embodiment of the invention;

FIG. 17 is an exemplary schematic diagram illustrating transmitting data with analysis object data to be transmitted in the second embodiment;

FIG. 18 is an exemplary schematic diagram of the analysis object data that are divided for transmission in the second embodiment;

FIG. 19 is an exemplary block diagram an HDC in the second embodiment;

FIG. 20 is an exemplary flowchart of a command execution process in the second embodiment;

FIG. 21 is an exemplary flowchart of a multiplexer process in the second embodiment;

FIG. 22 is an exemplary block diagram of an internal configuration of an analysis object data transmission control circuit in the second embodiment; and

FIG. 23 is an exemplary block diagram of an HDC according to a third embodiment of the invention.

### DETAILED DESCRIPTION

Various embodiments according to the invention will be described hereinafter with reference to the accompanying drawings. In general, according to one embodiment of the invention, a storage apparatus configured to connect to other apparatus through a communication interface, includes: a memory device; an analysis object data writing module configured to write, when a predetermined event occurs, analysis object data corresponding to the event in the memory device; a response data generator configured to generate response data corresponding to a request input through the communication interface; and a data output module configured to output the response data through the communication interface when the response data exist, and output the analysis object data stored in the memory device through the communication interface by using a non-transmission time interval of the response data.

According to another embodiment of the invention, An output signal generation circuit configured to generate an output signal to be transmitted through a communication interface, includes: a response data generator configured to generate a response data corresponding to a request input through the communication interface; and a data output module configured to output the response data through the communication interface when the response data exists, and output analysis object data generated according to occurrence of a predetermined event through the communication interface by using a non-transmission time interval of the response data.

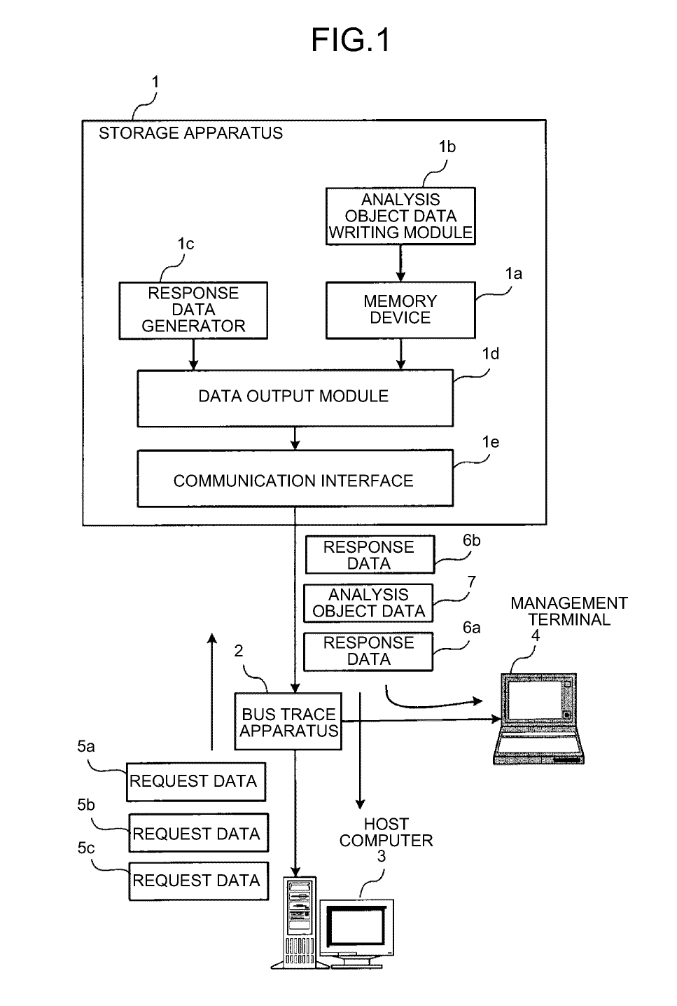

FIG. 1 is a schematic diagram illustrating any one of the embodiments. A storage apparatus 1 is connected to a host computer 3 through a bus trace apparatus 2. The bus trace apparatus 2 branches signals output from the storage apparatus 1, and output it to the host computer 3 and a management terminal 4.

The storage apparatus 1 communicates with the host computer 3 through a communication interface 1e. The storage apparatus 1 has a memory device 1a, an analysis object data writing module 1b, a response data generator 1c, and a data output module 1d.

The memory device 1a is, for example, a semiconductor memory. When a predetermined event occurs, the analysis object data writing module 1b write analysis object data 7 according to the occurred event in the memory device 1a. The response data generator 1c generates response data 6a and 6b corresponding to request data 5a, 5b, and 5c that are input through the communication interface 1e. When the response data 6a and 6b exist, the data output module 1d outputs the response data 6a and 6b through the communication interface 1e. When a non-transmission time interval of response data exists, the data output module 1d outputs the analysis object data 7 that is stored in the memory device 1a through the communication interface 1e by using the non-transmission time interval.

According to the storage apparatus 1, when a predetermined event occurs, the analysis object data 7 according to the occurred event is written in the memory device 1a by the analysis object data writing module 1b. The response data 6a and 6b corresponding to the request data 5a, 5b, and 5c that are input through the communication interface 1e are generated by the response data generator 1c. For some of the request data 5a, 5b and 5c, response data may not be needed. Moreover, even when the response data 6a and 6b are consecutively transmitted, there is the non-transmission time interval of the response data between when the transmission of the former response data 6a is completed until when the transmission of the latter response data 6b is started.

When the response data 6a and 6b exist, the response data 6a and 6b are output through the communication interface 1e by the data output module 1d. If the non-transmission time interval of the response data exits, the analysis object data 7 that are stored in the memory device 1a is output through the communication interface 1e by using the non-transmission time interval, by the data output module 1d.

The transmitted analysis object data 7 is branched by the bus trace apparatus 2, and input to the management terminal 4. The management terminal 4 acquires and stores the analysis object data 7. A system manager performs the failure analysis for the storage apparatus 1 with reference to the analysis object data 7 stored in the management terminal 4.

As described above, the analysis object data 7 is output by using the non-transmission time interval of response data. Hence, even when the data communication is continuously performed between the host computer 3 and the storage apparatus 1, the analysis object data 7 can be acquired from the storage apparatus 1. As a result, a high-speed failure analysis can be implemented during the operation of the system.

Next, details of the embodiments are described. In a first embodiment, analysis object data is transmitted when there is no response data to be transmitted from a storage apparatus. In an SAS/FC interface, for example, in terms of the specifications, idle data are transmitted when there is no data to be transmitted. In other words, the storage apparatus has a time interval during which the storage apparatus transmits no data. For example, this is a state where, although connection is established by “OPEN REQUEST” from the host computer, the storage apparatus has no transmitting frame. In the time interval when the response data do not exist, the idle data are transmitted from the storage apparatus. The idle data has no particular contents. Therefore, the storage apparatus can transmit meaningful data (analysis object data) instead of the idle data without violation of the transmission standard of the idle data.

The storage apparatus that is a target device transmits the analysis object data such as internal information and failure information of the device on the interface, instead of transmitting the idle data. The transmitted analysis object data can be acquired by using a commercially available bus trace apparatus.

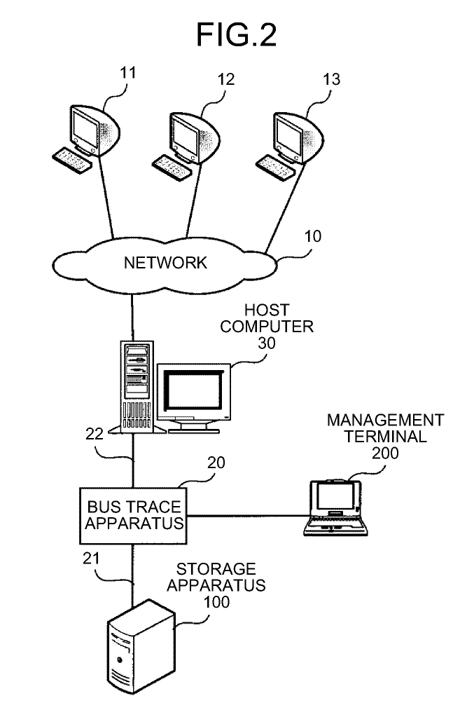

FIG. 2 is a diagram illustrating an example of a configuration of a system according to the first embodiment. The host computer 30 provides various services to terminals 11 to 13 via a network 10. The host computer 30 is connected to the storage apparatus 100 through a high-speed serial communication interface such as the SAS or the FC interface.

The storage apparatus 100 has a hard disk drive (HDD), and the like. The storage apparatus 100 stores therein various data required for the host computer 30 to provide services.

The storage apparatus 100 collects management information by using an internal controller, and stores the management information in the memory. For example, information (internal information) such as an access frequency, a number of turning on the power thereof, and a number of occurrences of reading/writing errors with respect to the HDD of the storage apparatus 100 is stored in the memory of the storage apparatus 100. In addition, the storage apparatus 100 transmits the internal information or other error information (analysis object data) through an interface cable 21 during an unoccupied time band.

A bus trace apparatus 20 is disposed between the storage apparatus 100 and the host computer 30. In other words, the storage apparatus 100 and the bus trace apparatus 20 are connected to each other by the interface cable 21, and the bus trace apparatus 20 and the host computer 30 are connected to each other by an interface cable 22.

The bus trace apparatus 20 is an apparatus that branches signals transmitted between the storage apparatus 100 and the host computer 30, and the bus trace apparatus 20 is also referred as a network tap. For example, signals transmitted through an optical fiber are branched by an optical coupler that is installed in the bus trace apparatus 20. The bus trace apparatus 20 outputs the branched signals to a management terminal 200.

The management terminal 200 is a computer for monitoring the data that are transmitted and received between the host computer 30 and the storage apparatus 100. The management terminal 200 analyzes the signals received from the bus trace apparatus 20 to acquire the data that are transmitted and received between the host computer 30 and the storage apparatus 100. For example, if the analysis object data are output from the storage apparatus 100, the analysis object data can be acquired by the management terminal 200.

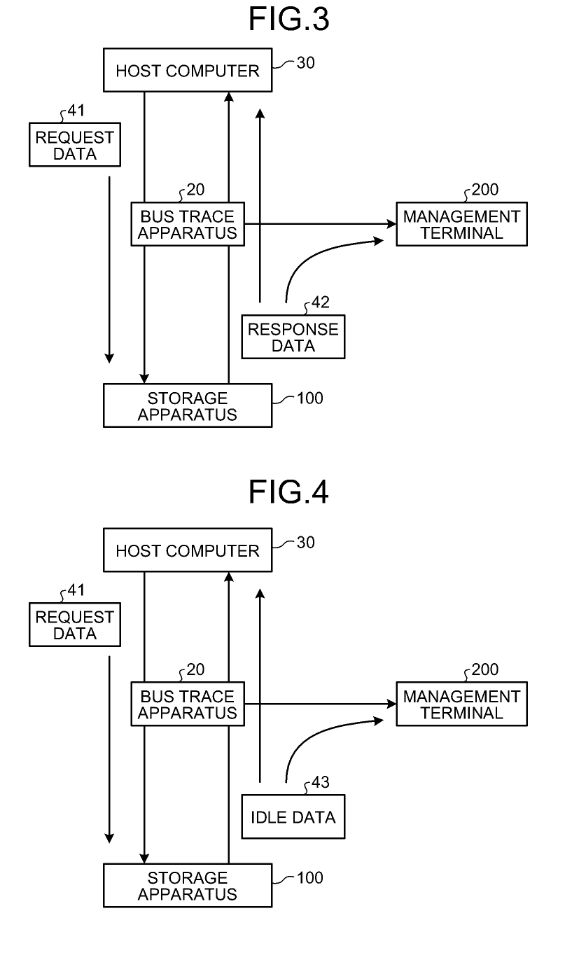

Next, data that are output from the storage apparatus 100 according to some situations are described with reference to FIGS. 3 to 5.

FIG. 3 is a block diagram illustrating an example where the storage apparatus outputs response data. Request data 41 for reading or writing data is transmitted from the host computer 30 to the storage apparatus 100. When there exists response data 42 with respect to the request data 41, the storage apparatus 100 transmits the response data 42 to the host computer 30. Then, the response data 42 are branched by the bus trace apparatus 20, and transmitted to the host computer 30 and the management terminal 200.

FIG. 4 is a block diagram illustrating an example when the storage apparatus outputs idle data. When there exist no response data responding the host computer 30 and no analysis object data to be transmitted, the storage apparatus 100 transmits idle data 43 to the host computer 30. Then, the idle data 43 are branched by the bus trace apparatus 20, and transmitted to the host computer 30 and the management terminal 200.

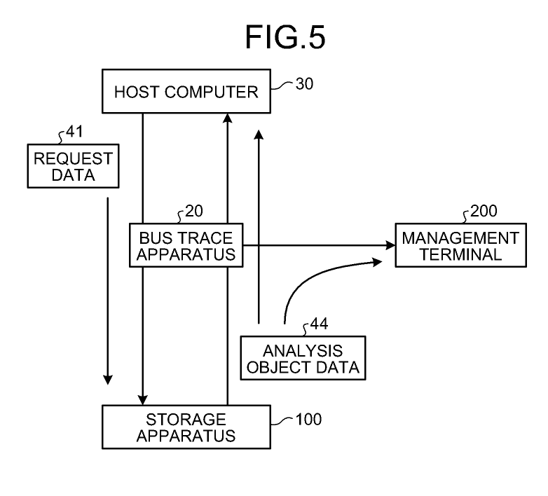

FIG. 5 is a diagram illustrating an example when the storage apparatus outputs analysis object data. When there exist no response data responding the host computer 30 but there exist the analysis object data 44 to be transmitted, the storage apparatus 100 transmits the analysis object data 44 to the host computer 30. Then, the analysis object data 44 are branched by the bus trace apparatus 20, and transmitted to the host computer 30 and the management terminal 200.

As illustrated in FIGS. 3 to 5, in the first embodiment, when the response data 42 does not exist but the analysis object data 44 to be transmitted does exist, the analysis object data 44 is transmitted instead of the idle data 43. The management terminal 200 acquires the response data 42, the idle data 43, and the analysis object data 44 through the bus trace apparatus 20. The management terminal 200 extracts only the analysis object data 44 from the acquired various data, and stores the extracted data.

In this manner, the analysis object data 44 can be acquired by the management terminal 200. In addition, since the storage apparatus 100 outputs the analysis object data 44 during the time when the response data 42 does not exist, the analysis object data 44 can be acquired while the data input/output between the host computer 30 and the storage apparatus 100 are maintained. Therefore, the failure analysis using the analysis object data 44 of the storage apparatus 100 can be performed when the service operation using the data of the storage apparatus 100 continues to be performed by the host computer 30.

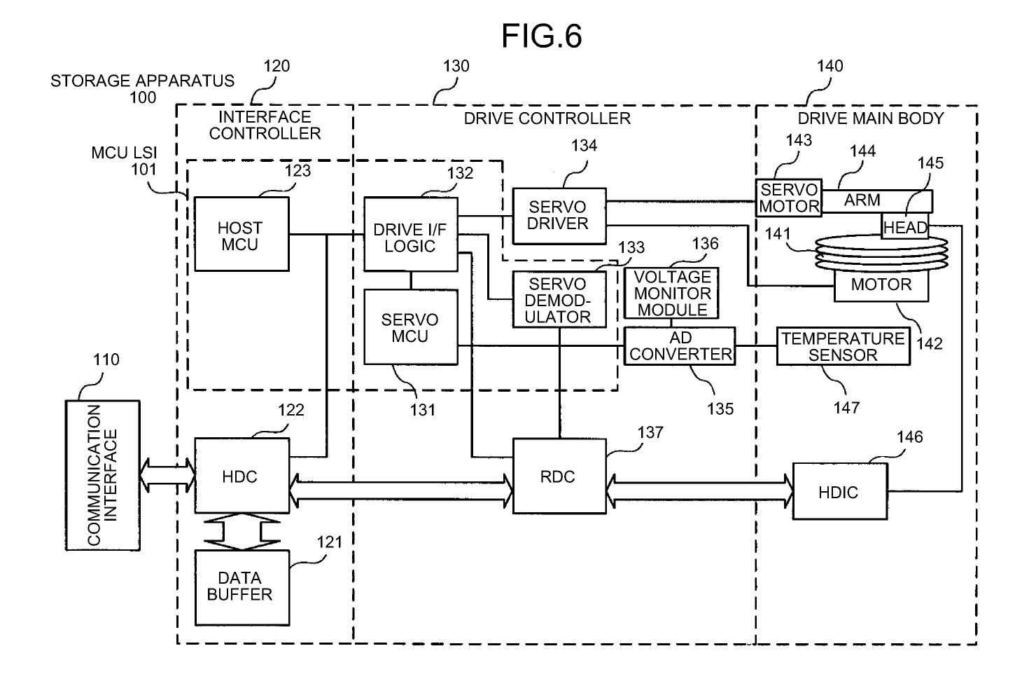

Next, the storage apparatus 100 and management terminal 200 that implement the aforementioned functions are described in detail. FIG. 6 is a block diagram illustrating a hardware configuration of the storage apparatus. FIG. 6 illustrates an example in which the storage apparatus 100 is a hard disk drive.

The storage apparatus 100 includes a communication interface 110, an interface controller 120, a drive controller 130, and a drive main body 140. The communication interface 110 performs data communication according to a high-speed communication protocol (SAS or FC). More specifically, the interface cable 21 illustrated in FIG. 2 is connected to the communication interface 110. The communication interface 110 receives data input from the interface cable 21, and transfers the data to the interface controller 120. The communication interface 110 transmits the data received from the interface controller 120 through the interface cable 21.

The interface controller 120 controls data communication through the communication interface 110. The interface controller 120 includes a data buffer 121, a hard disk controller (HDC) 122, and a host microcontroller unit (MCU) 123.

The data buffer 121 is a memory device that temporarily stores the data input and output through the communication interface 110. More specifically, cache data of the input/output data, the analysis object data that are to be transmitted through the communication interface 110, or the like are stored in the data buffer 121.

The HDC 122 controls reading data from a disk 141 or writing data in the disk 141 according to a read/write request input through the communication interface 110. For example, if the HDC 122 receives the data write request through the communication interface 110, the HDC 122 transmits information such as an address indicating a data write position and a data length to the host MCU 123, and transmits the write data to an RDC 137. If the HDC 122 receives the data read request through the communication interface 110, the HDC 122 transmits information such as an address indicating a data read position and a data length to the host MCU 123, and receives the read data from the RDC 137. The HDC 122 outputs the received read data through the communication interface 110.

The data buffer 121 is connected to the HDC 122. The HDC 122 uses some portions of a storage area of the data buffer 121 as a cache memory device for the read data or the write data.

In addition, if the HDC 122 receives the analysis object data that are to be transmitted to an external portion from the host MCU 123, the HDC 122 stores the analysis object data in the data buffer 121. After that, the HDC 122 transmits the analysis object data in the data buffer 121 through the communication interface 110 according to an instruction of the host MCU 123.

The host MCU 123 executes interface-control firmware (embedded software) to control the entire processes of the interface controller 120. The host MCU 123 generates the analysis object data of the storage apparatus 100, and stores the analysis object data in the embedded memory. The analysis object data are suitably updated by the host MCU 123 according to the operating situation of the storage apparatus 100. For example, the value of the analysis object data indicating the number of turning on the power is counted by the host MCU 123 every time when the power is turned on.

The drive controller 130 controls the operations of the drive main body 140. For example, the drive controller 130 controls a position of an arm 144, on which a head 145 is mounted, or controls a speed of a motor 142 for rotating the disk 141. In order to execute the functions, the drive controller 130 includes a servo MCU 131, a drive I/F logic 132, a servo demodulator 133, a servo driver 134, an AD converter 135, a voltage monitor module 136, and a read channel (RDC) 137.

The servo MCU 131 executes a drive-controlling firmware to control rotation of the motor 142 or a servo motor 143. The servo MCU 131 acquires voltage data or temperature data from the AD converter. In addition, when the voltage or the temperature exceeds a predetermined threshold value, the servo MCU 131 generates information indicating that the voltage or the temperature exceeds the predetermined threshold value to transmit the generated information to the host MCU 123 through the drive I/F logic 132.

The drive I/F logic 132 is connected to the host MCU 123, the servo MCU 131, the servo demodulator 133, the servo driver 134, and the RDC 137. In addition, the drive I/F logic 132 is an interface circuit for data communication among the host MCU 123, the servo MCU 131, the servo demodulator 133, and the servo driver 134.

The servo demodulator 133 receives the data read by the head 145 from the RDC 137, and extracts servo data. Next, the servo demodulator 133 transmits the servo data to the servo MCU 131 through the drive I/F logic 132. The servo data are information of identifying a track or block, which the head 145 reads. The servo MCU 131 can recognize a current position of the head 145 based on the servo data.

The AD converter 135 converts analog signals indicating the voltage and the temperature input from the voltage monitor module 136 and a temperature sensor 147 to digital signals. Next, the AD converter 135 transmits the converted digital signals of the voltage data and temperature data to the servo MCU 131.

The voltage monitor module 136 monitors the power voltage of the storage apparatus 100. Then, the voltage monitor module 136 outputs the power voltage value to the AD converter 135.

The RDC 137 transmits the write data, which are received from the HDC 122, to a head integrated chip (HDIC) 146. The RDC 137 transmits the read data, which are received from the HDIC 146, to the HDC 122. The RDC 137 transmits the servo data among the read data to the servo demodulator 133. In addition, the RDC 137 receives a read/write instruction, which is output from the servo MCU 131, through the drive I/F logic 132, and outputs the write/read signal to the HDIC 146 at the instructed timing. The servo MCU 131 recognizes the area located under the head 145 based on the servo data. When the head 145 is located on the area to be accessed, the servo MCU 131 output the read/write command.

The drive main body 140 has the disk 141, which is a storage medium, and a mechanism for writing and reading data on the disk 141. More specifically, the motor 142 corresponding to a mechanism for rotating the disk 141 is installed in the drive main body 140. The motor 142 rotates the disk 141 according to the control of the servo driver 134.

The arm 144 is provided to the servo motor 143. The head 145 is fixed to the front end of the arm 144. The servo motor 143 rotates the arm 144 around the position of the servo motor 143 according to the control of the servo driver 134. Therefore, the head 145 can be moved to a desired track on the disk 141. The head 145 is connected to the HDIC 146. The head 145 performs data write and read for the disk 141 by using a magnetic field, according to the control of the HDIC 146.

The temperature sensor 147 is installed in the drive main body 140. The temperature sensor 147 measures a temperature of the drive main body 140, and outputs a signal indicating the temperature to the AD converter 135.

The host MCU 123, the servo MCU 131, the drive I/F logic 132, and the servo demodulator 133 are installed in one MCU LSI 101.

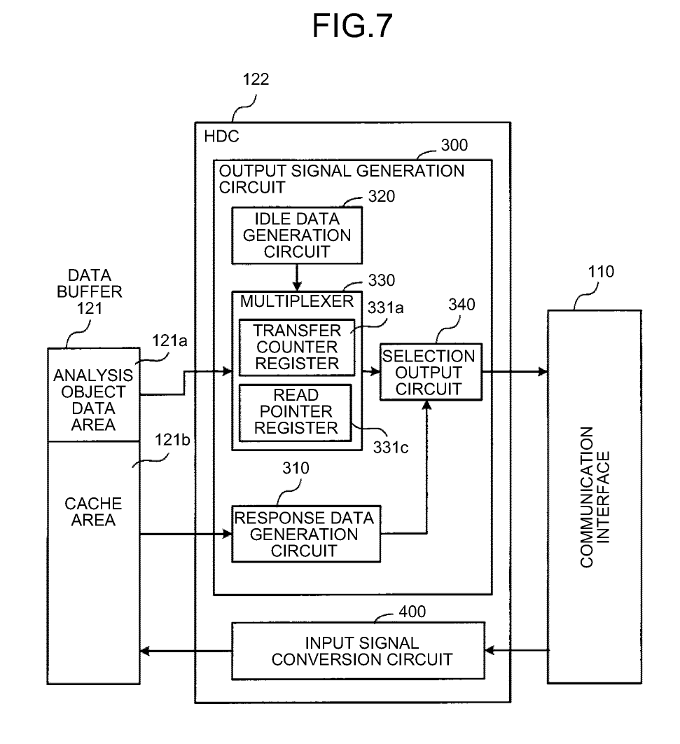

Next, a schematic configuration of the HDC 122 is described. [0056] FIG. 7 is a block diagram illustrating a configuration of the HDC 122 of the first embodiment. FIG. 7 illustrates a major configuration of the HDC 122. An analysis object data area 121a and a cache area 121b are provided in the data buffer 121. The analysis object data that are to be transmitted to an external portion are written in the analysis object data area 121a by the host MCU 123. A cache of the data that are transmitted to or received from the host computer 30 through the communication interface 110 is written in the cache area 121b.

The HDC 122 has an output signal generation circuit 300 and an input signal conversion circuit 400. The output signal generation circuit 300 is a circuit that generates a serial signal output through the communication interface 110. The input signal conversion circuit 400 is a circuit that converts the serial signal received through the communication interface 110, to the original data. The data that are converted by the input signal conversion circuit 400 are stored in the cache area 121b of the data buffer 121.

The output signal generation circuit 300 has a response data generation circuit 310, an idle data generation circuit 320, a multiplexer 330, and a selection output circuit 340. The response data that are transmitted from the cache area 121b of the data buffer 121 are stored in the response data generation circuit 310.

The idle data generation circuit 320 generates the idle data that are transmitted when there exists no response data to be transmitted to the host computer 30. The idle data are data of which pattern is determined in advance. The idle data generation circuit 320 output the generated idle data to the multiplexer 330.

The multiplexer 330 combines the idle data that are input from the idle data generation circuit 320 and the analysis object data that are stored in the analysis object data area 121a of the data buffer 121, and outputs the resulting data. More specifically, when the analysis object data are stored in the analysis object data area 121a, the multiplexer 330 acquires the analysis object data from the data buffer 121, and outputs the analysis object data to the selection output circuit 340. When the analysis object data is not stored in the analysis object data area 121a, the multiplexer 330 outputs the idle data that are input from the idle data generation circuit 320 to the selection output circuit 340.

In order to recognize the analysis object data in the analysis object data area 121a, a transfer counter register 331a and a read pointer register 331c are installed in the multiplexer 330.

A value (transfer count) indicating a data amount of the analysis object data stored in the analysis object data area 121a is set to the transfer counter register 331a. The data amount of the analysis object data is indicated by a multiple of a unit data length of data received or transmitted by the communication interface 110. When the communication interface 110 performs the SAS or FC communication, the data length of one frame of each communication becomes the unit data length. A pointer (read pointer) indicating a front address of the area, in which the analysis object data of the analysis object data area 121a is stored, is stored in the read pointer register 331c. The value of the transfer counter register 331a and the value of the read pointer register 331c are set by the host MCU 123.

If the transfer count is 1 or more, the multiplexer 330 determines that the analysis object data to be transmitted exist. If the analysis object data to be transmitted exist, the multiplexer 330 acquires the analysis object data from the area in the data buffer 121 indicated by the read pointer, divides the analysis object data by the transfer count, and outputs the divided analysis object data to the selection output circuit 340.

The selection output circuit 340 selects one of the data input from the response data generation circuit 310 and the data input from the multiplexer 330, and outputs the selected data to the communication interface 110. More specifically, when the response data for the host computer 30 is input from the response data generation circuit 310, the selection output circuit 340 outputs the response data to the communication interface 110. When the response data for the host computer 30 input from the response data generation circuit 310 does not exist, the selection output circuit 340 outputs the idle data or the analysis object data input from the multiplexer 330 to the communication interface 110.

Next, a transmitting data generation process of the interface controller 120 is described. The transmitting data generation process can be separated into an analysis object data write process of the host MCU 123, which writes the analysis object data in the data buffer 121, and an output data selection process of the output signal generation circuit 300.

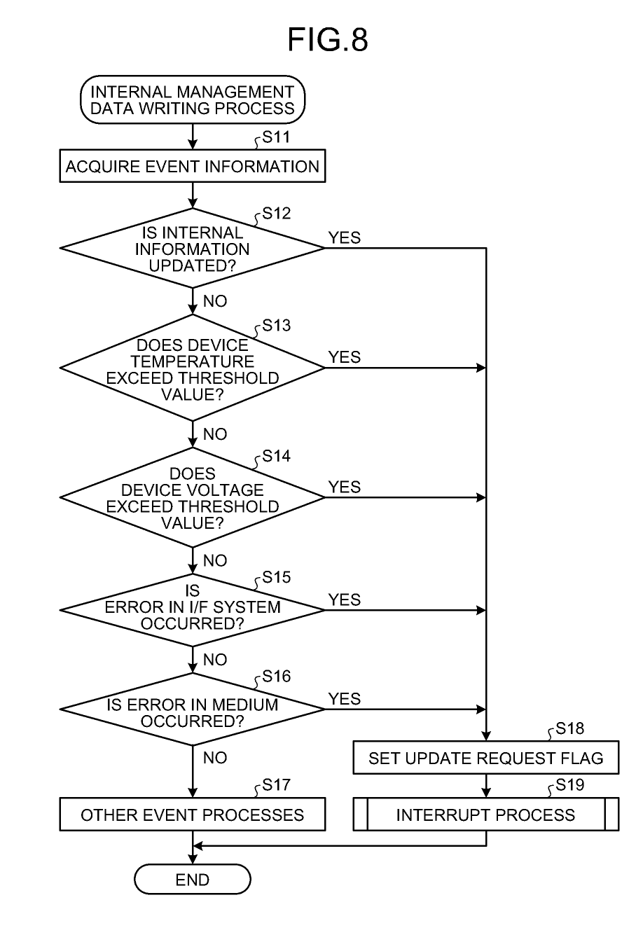

FIG. 8 is a flowchart illustrating the analysis object data write process of the host MCU. Hereinafter, the process illustrated in FIG. 8 is described.

The host MCU 123 acquires event information of an event occurred (S11). The information is output by individual tasks in the servo MCU 131 or in the host MCU 123.

The host MCU 123 determines based on the acquired event information whether internal information is updated (S12). When the internal information is updated, the process proceeds to S18. On the other hand, when the internal information is not updated, the process proceeds to S13.

The host MCU 123 determines based on the acquired event information whether the device temperature exceeds a threshold value (S13). As a result, when the device temperature is high, the process proceeds to S18. On the other hand, when the device temperature is not high, the process proceeds to S14.

The host MCU 123 determines based on the acquired event information whether the device voltage exceeds a threshold value (S14). When the device voltage is high, the process proceeds to S18. On the other hand, when the device voltage is not high, the process proceeds to S15.

The host MCU 123 determines based on the acquired event information whether an error in an interface (I/F) system is occurred (S15). When the error in the I/F system is occurred, the process proceeds to S18. On the other hand, when there is no error occurred in the I/F system, the process proceeds to S16.

The host MCU 123 determines based on the acquired event information whether an error in a medium (write/read error for the disk 14) is occurred (S16). When it is determined that the error in the medium is occurred, the process proceeds to S18. On the other hand, when it is determined that the error in the medium is not occurred, the process proceeds to S17.

When the aforementioned events are not to involve writing the analysis object data in the data buffer 121, the host MCU 123 performs a process according to the occurring event and ends the process (S17).

When the aforementioned events are to involve writing the analysis object data in the data buffer 121, the host MCU 123 sets an update request flag (S18). The update request flag is information indicating a request for updating the analysis object data area 121a in the data buffer 121. The update request flag is stored in an internal memory of the host MCU 123.

The host MCU 123 performs the interrupt process (S19). Then, after the interrupt process, the analysis object data write process ends.

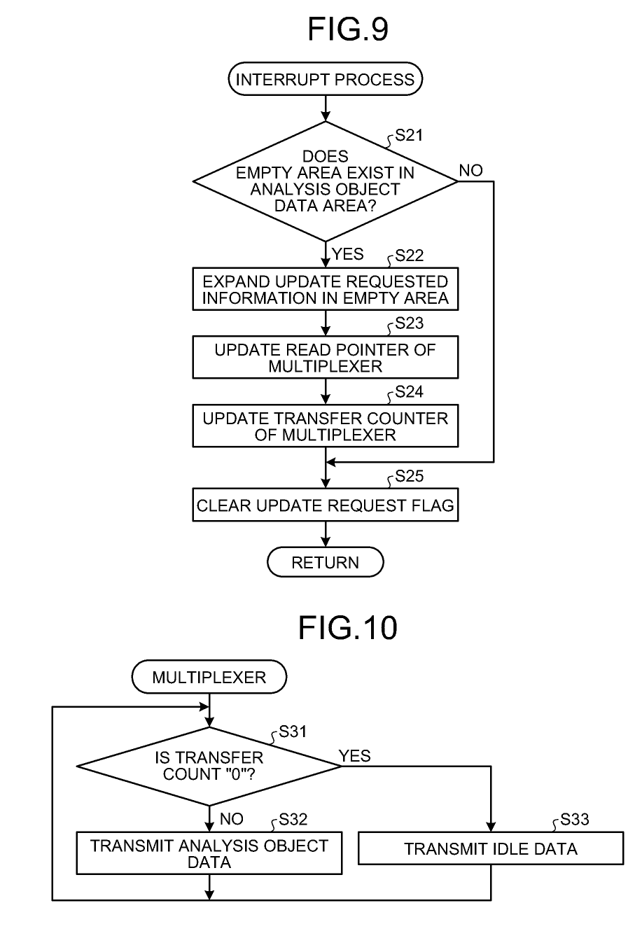

FIG. 9 is a flowchart illustrating the interrupt process. Hereinafter, the process illustrated in FIG. 9 is described.

The host MCU 123 determines whether an empty area exists in the analysis object data area 121a of the data buffer 121 (S21). If the empty area exits, the process proceeds to S22. If the empty area does not exist, the process proceeds to S25.

The host MCU 123 expands update-requested information in the empty area of the analysis object data area 121a in the data buffer 121 (S22). More specifically, if the internal information is updated, the host MCU 123 stores the internal information in the empty area of the analysis object data area 121a. If the device temperature exceeds the threshold value, the host MCU 123 stores the data indicating that the device temperature exceeds the threshold value and other detailed data of the device temperature in the empty area of the analysis object data area 121a. If the device voltage exceeds the threshold value, the host MCU 123 stores the data indicating that the device voltage exceeds the threshold value and other detailed data of the device voltage in the empty area of the analysis object data area 121a. If the media error occurs, the host MCU 123 stores the data indicating the media error and other detailed data of the media error in the empty area of the analysis object data area 121a.

The host MCU 123 updates the read pointer in the read pointer register 331c of the multiplexer 330 (S23). For example, when new analysis object data is stored in the analysis object data area 121a while there is no data stored in the analysis object data area 121a, the host MCU 123 sets the front address of the stored area as the read pointer.

The host MCU 123 updates the transfer count in the transfer counter register 331a of the multiplexer 330 (S24). For example, when the new analysis object data is stored in the analysis object data area 121a while there is no data stored in the analysis object data area 121a, the host MCU 123 sets a value corresponding to a data amount of the stored analysis object data (the value indicating the multiples of the unit data amount of the transmission) as the transfer count.

The host MCU 123 clears the update request flag and ends the interrupt process (S25). In this manner, by the host MCU 123, the analysis object data are stored in the data buffer 121, and the read pointer and the transfer count are set in the multiplexer 330. The multiplexer 330 selects the transmitting data by referring to the read pointer and the transfer count.

FIG. 10 is a flowchart illustrating a multiplexer process according to the first embodiment. Hereinafter, the process illustrated in FIG. 10 is described. The process illustrated in FIG. 10 is repetitively performed when the output of the multiplexer 330 is selected by the selection output circuit 340.

The multiplexer 330 determines whether the transfer count is “0” (S31). The transfer count of “0” denotes that the analysis object data to be transmitted does not exist. If the transfer count is “0”, the process proceeds to S33. If the transfer count is “1” or more, the process proceeds to S32.

The multiplexer 330 transmits the analysis object data to the selection output circuit 340 (S32). More specifically, the multiplexer 330 acquires data corresponding to the transfer count from the address indicated by the read pointer in the analysis object data area 121a, divides the data by unit data, and outputs the data to the selection output circuit 340. After transmitting the analysis object data, the process proceeds to S31.

The multiplexer 330 transmits the idle data generated by the idle data generation circuit 320 to the selection output circuit 340 (S33). Next, the process proceeds to S31.

In this manner, in the time interval during which the response data to the host computer 30 does not exist, the analysis object data can be transmitted.

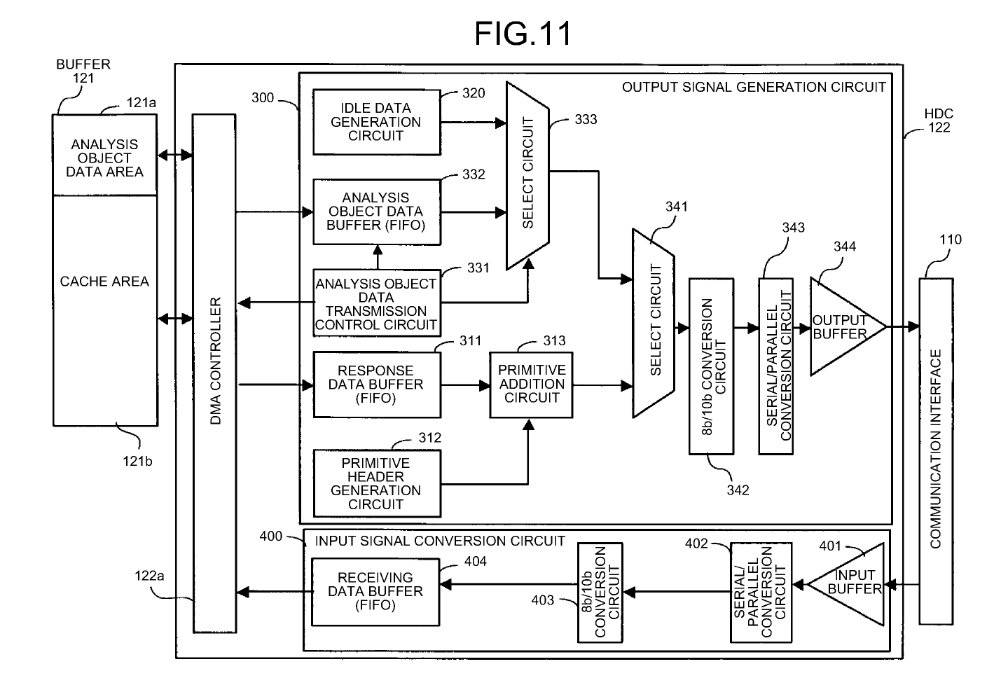

Next, a configuration of the HDC 122 is described in detail. FIG. 11 is a block diagram illustrating an internal configuration of the HDC 122. A direct memory access (DMA) controller 122a, the output signal generation circuit 300, and the input signal conversion circuit 400 are installed in the HDC 122. The DMA controller 122a controls data inputting and outputting between the data buffer 121 and each of the output signal generation circuit 300 and the input signal conversion circuit 400. More specifically, the DMA controller 122a transmits the data read from the data buffer 121 to the output signal generation circuit 300. Further, the DMA controller 122a writes the data input from the input signal conversion circuit 400 in the data buffer 121.

The output signal generation circuit 300 has a response data buffer 311, a primitive header generation circuit 312, and a primitive addition circuit 313, as detailed components of the response data generation circuit 310. Further, the output signal generation circuit 300 has an analysis object data transmission control circuit 331, an analysis object data buffer 332, and a selection circuit 333, as detailed components of the multiplexer 330. In addition, the output signal generation circuit 300 has a selection circuit 341, an 8b/10b conversion circuit 342, a serial/parallel conversion circuit 343, and an output buffer 344, as detailed components of the selection output circuit 340.

The response data buffer 311 is a first-in first-out (FIFO) buffer, and stores the response data transmitted from the data buffer 121 by the DMA controller 122a. The response data stored in the response data buffer 311 is sequentially output to the primitive addition circuit 313.

The primitive header generation circuit 312 generates information (SOF primitive) indicating the starting position of the response data and information (EOF primitive) indicating the ending position thereof. The primitive header generation circuit 312 outputs data of a predetermined pattern indicating the primitive to the primitive addition circuit 313.

The primitive addition circuit 313 adds the primitive input from the primitive header generation circuit 312 before and after the response data input from the response data buffer 311. Next, the primitive addition circuit 313 outputs the primitive-added response data to the selection circuit 341.

The analysis object data transmission control circuit 331 controls transmitting the analysis object data from the data buffer 121 to the analysis object data buffer 332. More specifically, the analysis object data transmission control circuit 331 designates the front address of storing the analysis object data and the data length of the analysis object data, and instructs the DMA controller 122a to perform DMA transmission to the analysis object data buffer 332. If the analysis object data is stored in the analysis object data buffer 332, the analysis object data transmission control circuit 331 outputs a signal indicating that there exist the analysis object data, to the selection circuit 333.

The analysis object data buffer 332 is a FIFO buffer, and stores the analysis object data transmitted from the data buffer 121 by the DMA controller 122a. The analysis object data stored in the analysis object data buffer 332 are output to the selection circuit 333.

The analysis object data output from the analysis object data buffer 332 and the idle data output from the idle data generation circuit 320 are input to the selection circuit 333. The selection circuit 333 recognizes based on the signal from the analysis object data transmission control circuit 331 whether the analysis object data exist in the analysis object data buffer 332. When the analysis object data exist, the selection circuit 333 selects the analysis object data input from the analysis object data buffer 332. On the other hand, when the analysis object data does not exist, the selection circuit 333 selects the idle data input from the idle data generation circuit 320. Next, the selection circuit 333 outputs the selected data to the selection circuit 341.

When the response data are input from the primitive addition circuit 313, the selection circuit 341 selects the response data. On the other hand, when the response data are not input from the primitive addition circuit 313, the selection circuit 341 selects the idle data or the analysis object data input from the selection circuit 333. Next, the selection circuit 341 outputs the selected data to the 8b/10b conversion circuit 342.

The 8b/10b conversion circuit 342 converts the data input from the selection circuit 341 in an 8b/10b scheme. The 8b/10b conversion circuit 342 outputs the converted data to the serial/parallel conversion circuit 343.

The serial/parallel conversion circuit 343 converts the data input from the 8b/10b conversion circuit 342 to a serial signal. Next, the serial/parallel conversion circuit 343 outputs the converted-serial signal data to the output buffer 344.

The output buffer 344 temporarily latches the data input from the serial/parallel conversion circuit 343, and outputs the data to the communication interface 110. According to the aforementioned configuration, the output signal generation circuit 300 can be implemented.

The input signal conversion circuit 400 has an input buffer 401, a serial/parallel conversion circuit 402, an 8b/10b conversion circuit 403, and a receiving data buffer 404.

The data received through the communication interface 110 are input to the input buffer 401. The input buffer 401 temporarily latches the input data, and outputs the data to the serial/parallel conversion circuit 402.

The serial/parallel conversion circuit 402 converts the data input from the input buffer 401 to a parallel signal. Next, the serial/parallel conversion circuit 402 outputs the converted parallel signal data to the 8b/10b conversion circuit 403.

The 8b/10b conversion circuit 403 converts the data input from the serial/parallel conversion circuit 402 to the original data in the 8b/10b scheme. The 8b/10b conversion circuit 403 output the converted data to the receiving data buffer 404.

The receiving data buffer 404 is a FIFO buffer, and stores the input data. The receiving data stored in the receiving data buffer 404 is DMA-transmitted to the cache area 121b of the data buffer 121 through the DMA controller 122a.

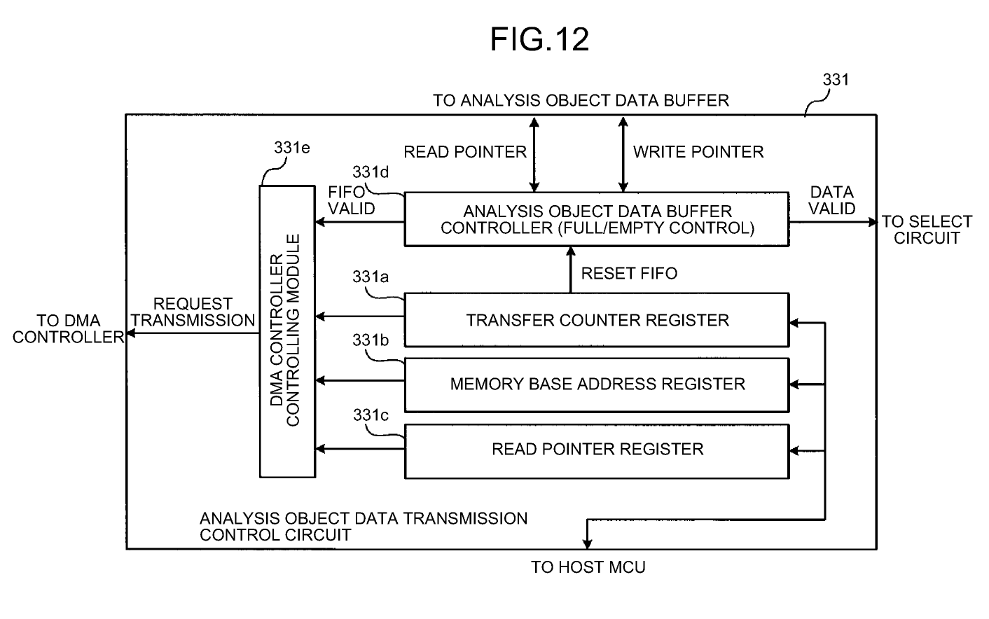

Next, an internal configuration of the analysis object data transmission control circuit 331 is described in detail. FIG. 12 is a block diagram illustrating the internal configuration of the analysis object data transmission control circuit 331. The analysis object data transmission control circuit 331 has a transfer counter register 331a, a memory base address register 331b, a read pointer register 331c, an analysis object data buffer controller 331d, and a DMA controller controlling module 331e.

The transfer counter register 331a, the memory base address register 331b, and the read pointer register 331c are connected to the host MCU 123. The host MCU 123 sets data in the transfer counter register 331a, the memory base address register 331b, and the read pointer register 331c. The transfer count is set in the transfer counter register 331a. A memory base address is set in the memory base address register 331b. The memory base address is a front address of the analysis object data area 121a in the memory space. The read pointer is set in the read pointer register 331c. In this example, a value of the read pointer is a value of difference from the memory base address.

The analysis object data buffer controller 331d is connected to the analysis object data buffer 332. The analysis object data buffer controller 331d performs FULL/EMPTY control for the FIFO by comparing the read pointer and the write pointer of the analysis object data buffer 332. In the FULL/EMPTY control, if the value of the read pointer and the value of the write pointer are equal to each other, it is determined that the analysis object data buffer 332 according to the FIFO is EMPTY. If the value of the write pointer is “the value of the read pointer −1”, it is determined that the analysis object data buffer 332 according to the FIFO is FULL. During the time when the analysis object data buffer 332 is empty (not FULL), the analysis object data buffer controller 331d outputs a signal “FIFO Valid” indicating that the analysis object data buffer 332 is valid, to the DMA controller controlling module 331e. During the time when valid data exist in the analysis object data buffer 332 (not EMPTY), the analysis object data buffer controller 331d output a signal “DATA Valid” indicating that valid data exist in the analysis object data buffer 332, to the selection circuit 333. If a new value is set in the transfer counter register by the host MCU 123, the analysis object data buffer controller 331d resets the analysis object data buffer 332.

The DMA controller controlling module 331e is connected to the DMA controller 122a. The DMA controller controlling module 331e outputs a DMA transmission request to the DMA controller 122a by referring to the values set in the transfer counter register 331a, the memory base address register 331b, and the read pointer register 331c. More specifically, the DMA controller controlling module 331e repetitively outputs the DMA transmission request of a unit data length to the DMA controller 122a, with reference to an address that is formed by adding the read pointer to the memory base address. The starting address of the DMA transmitting data is added with the unit data length every time when the DMA transmission request is output. The number of times of the output of the DMA transmission request is equal to the value of the transfer count. If the signal “FIFO Valid” is stopped being sent from the analysis object data buffer controller 331d, the DMA controller controlling module 331e determines that the analysis object data buffer 332 is FULL, and stops outputting the DMA transmission request.

According to the aforementioned circuit configuration, the analysis object data can be output from the storage apparatus 100 through communication interface 110. The output analysis object data are branched by the bus trace apparatus 20 to be input to the management terminal 200.

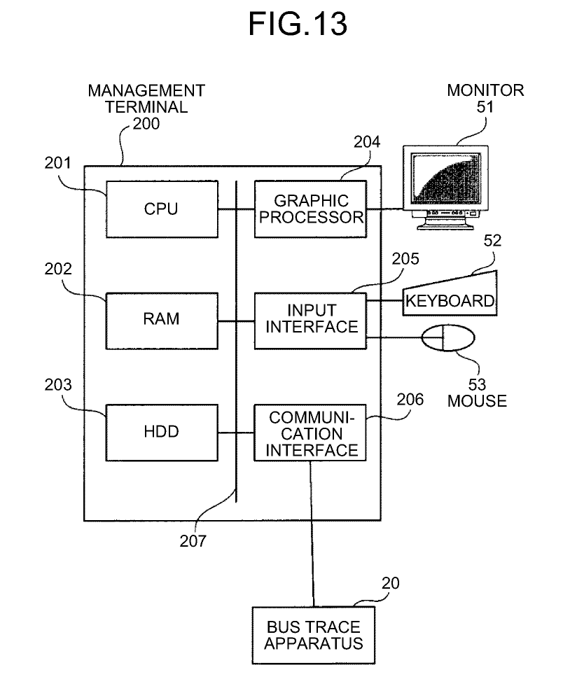

FIG. 13 is a schematic diagram illustrating an example of a hardware configuration of the management terminal 200 used in the first embodiment. The entire management terminal 200 is controlled by a central processing unit (CPU) 201. A random-access memory (RAM) 202, a hard disk drive (HDD) 203, a graphic processor 204, an input interface 205, and a communication interface 206 are connected to the CPU 201 via a bus 207.

The RAM 202 is used as a main memory device of the management terminal 200. At least a portion of operating system (OS) programs and application programs that are executed by the CPU 201 is temporarily stored in the RAM 202. Various data necessary for the processes executed by the CPU 201 are stored in the RAM 202. The HDD 203 is used as a secondary memory device of the management terminal 200. The OS programs, application programs, and various data are stored in the HDD 203. Alternatively, semiconductor memory devices such as a flash memory can be used as the secondary memory device.

A monitor 51 is connected to the graphic processor 204. The graphic processor 204 displays an image on a screen of the monitor 51 according to a command from the CPU 201. A display apparatus using a cathode ray tube (CRT) or a liquid crystal display apparatus can be used as the monitor 51.

A keyboard 52 and a mouse 53 are connected to the input interface 205. The input interface 205 transmits signals that are transmitted from the keyboard 52 or the mouse 53 to the CPU 201 via the bus 207. The mouse 53 is an example of the pointing device. Alternatively, other pointing devices can be used. The other pointing devices includes a touch panel, a tablet, a touch pad, a track ball, and/or the like.

The communication interface 206 is connected to the bus trace apparatus 20 through an interface cable. The communication interface 206 receives a signal that is output from the storage apparatus 100 through the bus trace apparatus 20. Next, the communication interface 206 transmits the received signal to the CPU 201. [0114] The processing of the first embodiment can be implemented by the aforementioned hardware configuration.

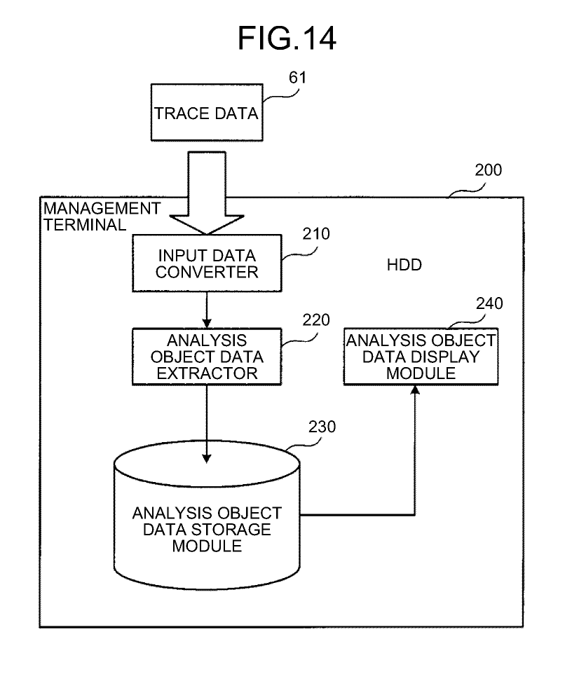

FIG. 14 is a block diagram illustrating the management terminal 200. The management terminal 200 has an input data converter 210, an analysis object data extractor 220, an analysis object data storage module 230, and an analysis object data display module 240.

Trace data 61 that are branched by the bus trace apparatus 20 is input to the input data converter 210. The input data converter 210 analyzes the input data. For example, the input data converter 210 converts a serial signal to a parallel signal, and performs an 8b/10b conversion to generated to-be-transmitted data.

The analysis object data extractor 220 extracts the analysis object data from the data generated by the input data converter 210. More specifically, as the data output from the storage apparatus 100, there are the response data to the host computer 30, the idle data that are output when the response data to be output and the analysis object data to be output do not exist, and the analysis object data that are the internal information or the error information of the storage apparatus 100.

Predetermined pattern primitives are disposed before and after the response data. Therefore, the response data can be specified by detecting the primitives. The idle data is always generated to have a single pattern. Therefore, the idle data can be specified by detecting the predetermined single pattern. The analysis object data extractor 220 determines that data excluding the response data and the idle data among the input data are the analysis object data. The analysis object data extractor 220 stores the acquired analysis object data in the analysis object data storage module 230.

In the communication interface such as the SAS or FC communication interface, data are uniquely scrambled (8b/10b conversion) with its standard, and transmitted. Only a particular pattern, which is a K character, is allocated to the primitive added to the response data. Therefore, the idle data and the primitive do not coincide with each other. This coincidence is ensured as similar to the case in which the normal data transmitted by the storage apparatus 100 and the primitive do not in coincide with each other. The analysis object data that are transmitted by the storage apparatus 100 instead of the idle data are also scrambled according to the standard of the communication interface to be transmitted. Therefore, similarly to the case of the idle data, a front or rear end of the analysis object data is not in coincidence with the primitive.

The analysis object data storage module 230 stores the analysis object data. For example, a portion of a storage area of the HDD 203 is used as the analysis object data storage module 230.

The analysis object data display module 240 displays the analysis object data stored in the analysis object data storage module 230 on the monitor 51, in response to a manipulation input.

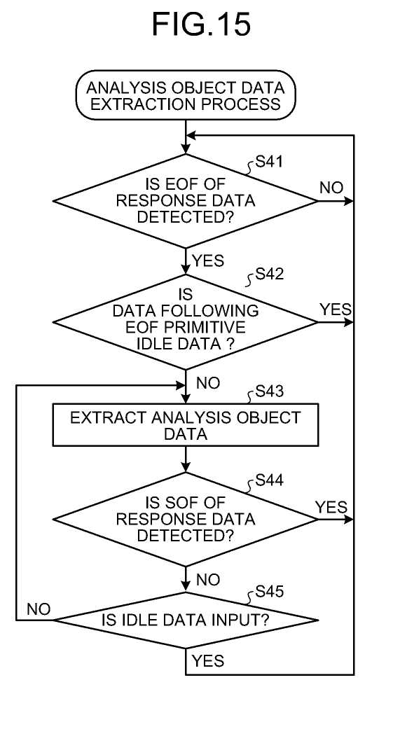

Next, an analysis object data extraction process is described. FIG. 15 is a flowchart illustrating the analysis object data extraction process. Hereinafter, the process illustrated in FIG. 15 is described.

The analysis object data extractor 220 determines whether the EOF primitive of the response data is detected (S41). When the EOF primitive is detected, the process proceeds to S42. When the EOF primitive is not detected, the process in S41 is repeated.

The analysis object data extractor 220 determines whether data following the EOF primitive is the idle data (S42). If the data is the idle data, the process proceeds to S41. If the data is not the idle data, the process proceeds to S43.

The analysis object data extractor 220 determines the data following the EOF primitive is the analysis object data, and extracts the following data (S43). The analysis object data extractor 220 sequentially stores the extracted analysis object data in the analysis object data storage module 230.

The analysis object data extractor 220 determines whether the SOF primitive of the response data following the analysis object data is input (S44). When the SOF primitive is detected, the process proceeds to S41. When the SOF primitive is not detected, the process proceeds to S45.

The analysis object data extractor 220 determines whether the idle data following the analysis object data is input (S45). When the idle data is input, the process proceeds to S41. When the idle data is not input, the process proceeds to S43, in which the extraction of the analysis object data is performed.

In this manner, the analysis object data is output from the storage apparatus 100 as needed, so that the analysis object data can be acquired by the management terminal 200. The analysis object data has a plurality of kinds of data such as internal information and error information that the storage apparatus 100 collects by performing internal monitoring thereof. In a configuration where header data corresponding to each kind of data are added to the front end of the analysis object data, the kind of data can be easily identified in the management terminal 200.

Next, a second embodiment is described. In the second embodiment, analysis object data is transmitted by using a non-transmission time interval of response data that occurs between consecutively transmitted response data.

Referring to a communication interface standard, even when the response data is to be consecutively transmitted, the non-transmission time interval of the response data exists between when the transmission of the former response data is ended and when the transmission of the latter response data is started. In the second embodiment, the analysis object data is transmitted by using the non-transmission time interval of the response data. A system configuration according to the second embodiment is the same as the system configuration illustrated in FIG. 2 according to the first embodiment. Therefore, hereinafter, communication functions between components in the second embodiment are described by using the same reference numerals of the components illustrated in FIG. 2.

When transmitting the response data, the storage apparatus 100 consecutively transmits the response data. However, even when the response data are consecutively transmitted, there exists the non-transmission time interval of the response data from when the transmission of the former response data is ended until when the transmission of the latter response data is started. By using the non-transmission time interval, the internal information or failure information such as errors of the storage apparatus 100 can be transmitted as the analysis object data during the non-transmission time interval of response data.

For example, a frame used in the SAS/FC interface is protected with the SOF primitive and the EOF primitive before and after the frame. Idle data are transmitted between two frames. During the time when the idle data is transmitted, analysis object data may be transmitted instead. However, since the data does not exist within the frame, the host computer 30 receiving the data determines that the data are invalid data.

Due to the transmission of valid data between the frames, the interval between the frames is lengthened in comparison with a conventional case, so that the transmission scheme may influence performance. However, the transmission scheme does not violate the SAS/FC interface standards.

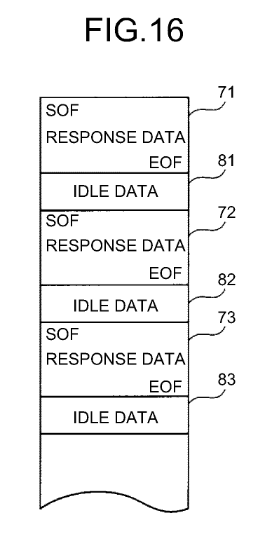

FIG. 16 is a schematic diagram illustrating transmitting data when the analysis object data to be transmitted does not exist. The response data 71, 72, 73, . . . that are divided by the unit data length (for example, a frame unit) are transmitted from the storage apparatus 100. The idle data 81, 82, 83, . . . are inserted between the response data 71, 72, 73, . . . . The SOF and EOF primitives are set at the front and rear ends of each of the response data 71, 72, 73, . . . . Due to the primitives, the response data 71, 72, 73, . . . and the idle data 81, 82, 83, . . . are identified in the host computer.

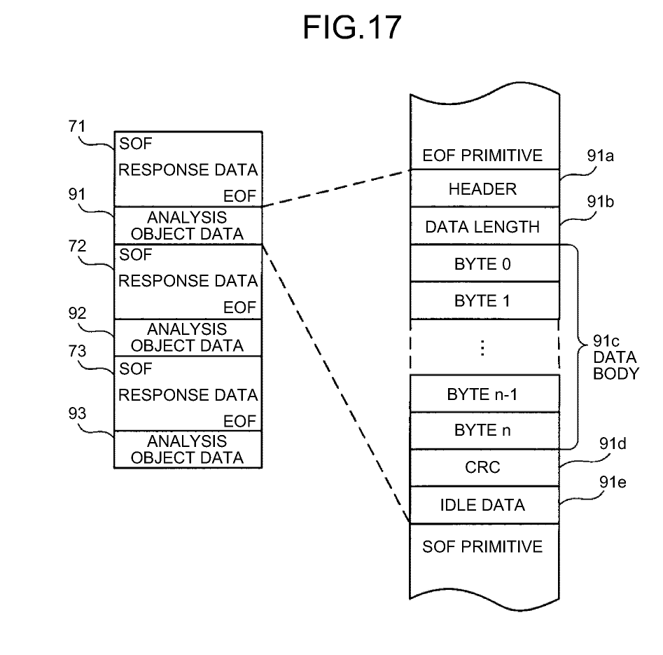

FIG. 17 is a schematic diagram illustrating transmitting data of when the analysis object data to be transmitted exist. When the analysis object data 91, 92, 93, . . . to be transmitted exist, the analysis object data 91, 92, 93, . . . instead of the idle data 81, 82, 83, . . . are inserted between the response data 71, 72, 73, . . . that are transmitted from the storage apparatus 100.

The analysis object data 91 is started to be transmitted right after the last EOF primitive of the response data 71. A header 91a is disposed at the front end of the analysis object data 91. A pattern of the header 91a is a single pattern such as “ALL ZERO”. A data length 91b is disposed after the header 91a. The data length 91b denotes a data capacity from the header 91a to the cyclic redundancy check (CRC) 91d. A data body 91c is set after the data length 91b. In the example illustrated in FIG. 17, data of n bytes where n is a natural number is included in one piece of analysis object data 91. The CRC from the header 91a to the data body 91c is set after the data body 91c. Idle data 91e is transmitted after the CRC 91d.

In this manner, in the second embodiment, a single pattern such as “ALL ZERO” is used for the header 91a. In general, in order to provide potential differences to the idle data (in order for potentials not to be biased), the idle data have a random data pattern (data pattern in which bits of 0 and bits of 1 are mixed) so as not to have a single pattern. Since the header 91a is formed in a single pattern (all bits are 0, or all bits are 1), the header 91a can be distinguished from the idle data.

In the second embodiment, by adding the CRC, the entire contents of the analysis object data are ensured. Therefore, even when the idle data becomes the same as the header pattern, if the CRC is not matched, it can be determined that the data are not the analysis object data. In other words, the idle data and the analysis object data can be accurately determined.

The non-transmission time interval of response data between the transmissions of the response data is short. Therefore, there is also a limitation to a data amount of the analysis object data that are transmitted between the transmissions of the response data. When the analysis object data cannot be transmitted to be transmitted during one non-transmission time interval of the response data, the storage apparatus 100 divides the analysis object data and transmit the divided data.

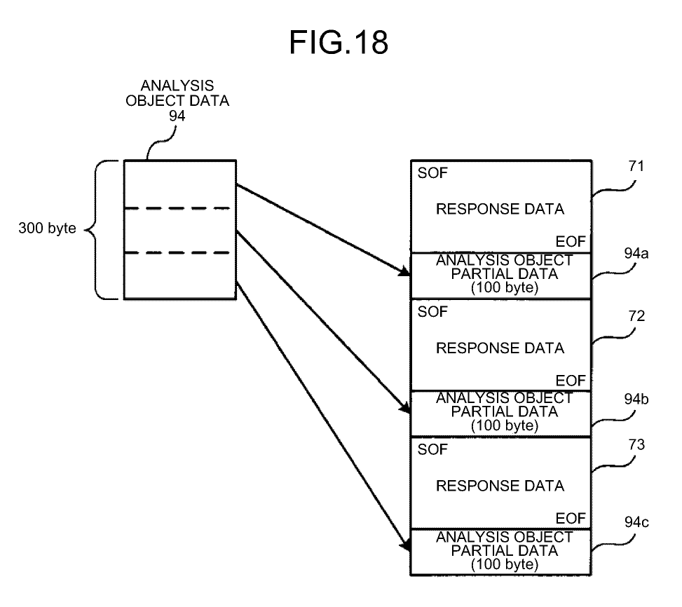

FIG. 18 is a schematic diagram illustrating an example of the analysis object data that are divided and transmitted. In the example illustrated in FIG. 18, it is assumed that only 100 bytes of the analysis object data can be transmitted during one non-transmission time interval of response data. At this time, if 300 bytes of the analysis object data 94 is needed to be transmitted, the analysis object data 94 are divided into three partial data. By the division of the analysis object data 94, three analysis object partial data 94a, 94b, and 94c each having 100 bytes are generated. Next, the analysis object partial data 94a, 94b, and 94c are transmitted between the transmissions of the response data 71, 72, 73 (in the non-transmission time interval).

Accordingly, even when the transmission of the response data is consecutively performed without disconnection (when the analysis object data cannot be output within the one idle data period), the valid data can be acquired.

When there is a problem caused due to a command input to the storage apparatus 100 through the communication interface 110, error information is transmitted from the storage apparatus 100 to the host computer 30. That is to say, for example, in the SAS or FC interface, when the command is ended as “CHECK STATUS”, detailed information is notified to the host computer 30 as the sense data. However, since the sense data has a limitation in terms of the transmission length, all the necessary information may not be able to be notified. Since transmission of detailed information on the error at the time of command execution has a limited capacity in terms of standards, sufficient information suitable for the failure analysis may not be transmitted.

In the second embodiment, in the case when the response data including detailed information due to the command error (for example, “CHECK STATUS” of the SAS/FC interface) need to be transmitted, detailed information that causes the error is transmitted as the analysis object data instead of the idle data between the response data.

Additional error information that is transmitted as the analysis object data includes an accumulated time from when power of the device is turned on and a device voltage. If the error is in a medium system, the additional error information includes an arbitrary register value of a medium controller, a number of retries, and a physical sector position address. If the error is in an interface system, the additional error information includes an arbitrary register value of an interface controller and an output signal setup value of a PHY chip (communication circuit of interface of a physical layer. At the time of occurrence of the errors, the error information that is not notified in the predetermined sense data according to the standard is transmitted between the frames, so that the error information can be analyzed in real time.

Next, a hardware configuration of the storage apparatus 100 for transmitting the analysis object data by using the non-transmission time interval of response data is described. The basic hardware configuration is the same as that of the first embodiment illustrated in FIG. 6. The internal configuration of the HDC is different from that of the first embodiment.

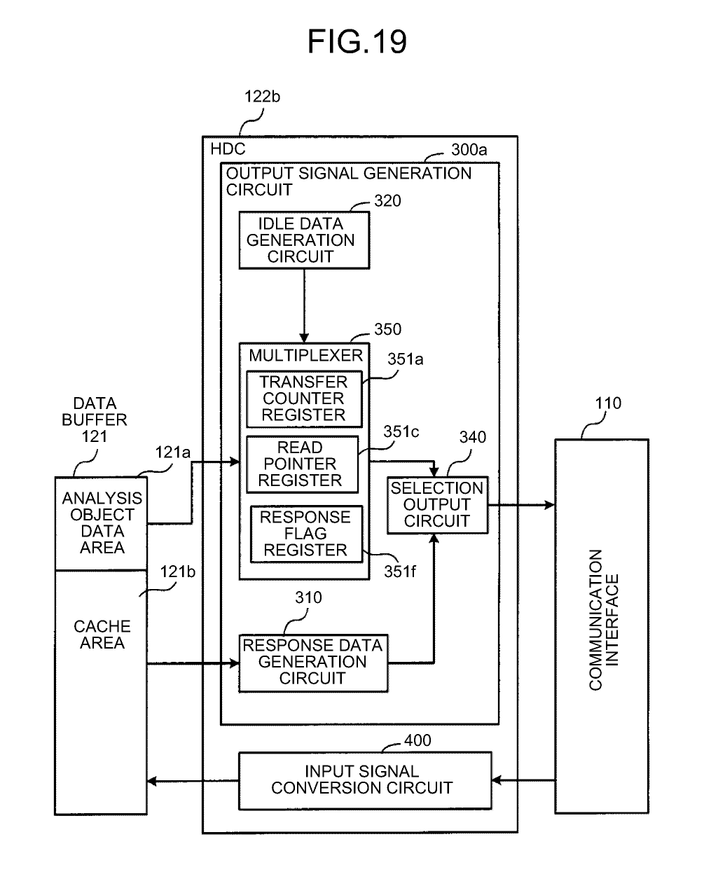

FIG. 19 is a block diagram illustrating a configuration of an HDC according to the second embodiment. In the internal configuration of the HDC 122b according to the second embodiment, only a multiplexer 350 of the output signal generation circuit 300a is different from the configuration of the first embodiment illustrated in FIG. 7. Therefore, the same elements as those of the first embodiment are denoted by the same reference numerals of FIG. 7, and description thereof is omitted.

Unlike the first embodiment, the multiplexer 350 has a response flag register 351f, a transfer counter register 351a, and a read pointer register 351c. A response flag indicating the occurrence of an error with respect to a command is set in the response flag register 351f.

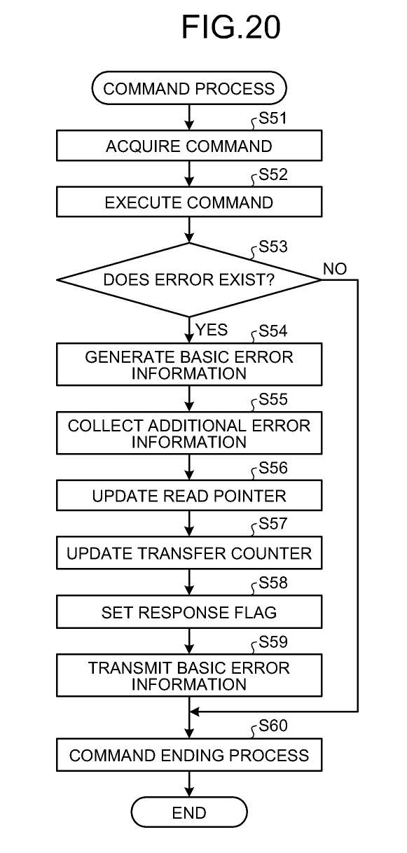

Next, a process performed by the host MCU 123 receiving the command is described. FIG. 20 is a flowchart illustrating a command execution process. Hereinafter, the process illustrated in FIG. 20 is described.

The host MCU 123 acquires a command input through the communication interface 110 (S51). The host MCU 123 executes the acquired command (S52).

The host MCU 123 determines based on the result of execution of the command whether an error exists (S53). At this time, it is also determined whether the error is in the medium system or the interface system. When the error exists, the process proceeds to S54. When the error does not exist, the process proceeds to S60.

The host MCU 123 generates basic error information (S54). In the case of the SAS or FC interface, the sense data are the basic error information. The host MCU 123 collects additional error information (group of information including detailed information that is not included in the basic error information). More specifically, the host MCU 123 acquires the “accumulated time from when the power of the device is turned on and the “device voltage”. When the error is in the medium system, the host MCU 123 acquires the “arbitrary register value of the medium controller”, the “number of retry”, and “physical sector position address”. When the error is in the interface, the host MCU 123 acquires the “value of arbitrary register of the interface controller” and the “value set to the output signal of the PHY chip”. The host MCU 123 stores the collected additional error information as the analysis object data in the analysis object data area 121a of the data buffer 121.

The host MCU 123 updates the read pointer (S56). More specifically, the host MCU 123 sets the front-end address of the storage area that stores the additional error information as the read pointer to the read pointer register 351c in the multiplexer 350.

The host MCU 123 updates the transfer counter (S57). More specifically, the host MCU 123 sets the number used to divide the analysis object data to be transmitted as the transfer counter to the transfer counter register 351a in the multiplexer 350.

The host MCU 123 sets the response flag (S58). More specifically, the host MCU 123 sets the value “1” indicating that an error occurs to the response flag register 351f in the multiplexer 350.

The host MCU 123 performs a process of transmitting the response data including the basic error information (S59). The host MCU 123 performs a command ending process (S60).

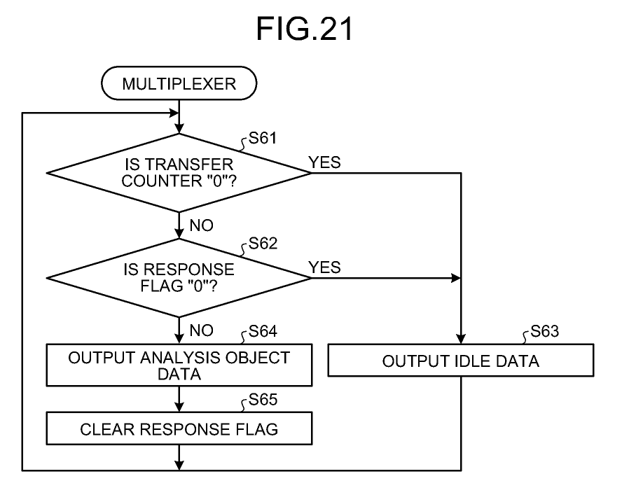

Next, a multiplexer process is described. FIG. 21 is a flowchart illustrating the multiplexer process according to the second embodiment. Hereinafter, the process illustrated in FIG. 21 is described.

The multiplexer 350 determines whether the transfer count is 0 (S61). If the transfer count is 0, the process proceeds to S63. If the transfer count is not 0, the process proceeds to S62.

The multiplexer 350 determines whether the response flag is 0 (S62). If the response flag is 0, the process proceeds to S63. If the response flag is not 0, the process proceeds to S64.

When the transfer counter is 0 or the response flag is 0, the multiplexer 350 outputs the idle data to the selection output circuit 340 (S63). After that, the process proceeds to S61.

When the transfer counter is 1 or more and the response flag is 1, the multiplexer 350 outputs the analysis object data to the selection output circuit 340 (S64). Then, the multiplexer 350 clears the response flag (S65). More specifically, the multiplexer 350 sets “0” to the response flag register 351f. After that, the process proceeds to S61.

Next, a detailed internal configuration of the output signal generation circuit 300a for implementing the process is described. The configuration of the output signal generation circuit 300a according to the second embodiment is the same as the configuration illustrated in FIG. 11 except for functions of an analysis object data transmission control circuit 351. Therefore, an internal configuration of the analysis object data transmission control circuit 351 is described.

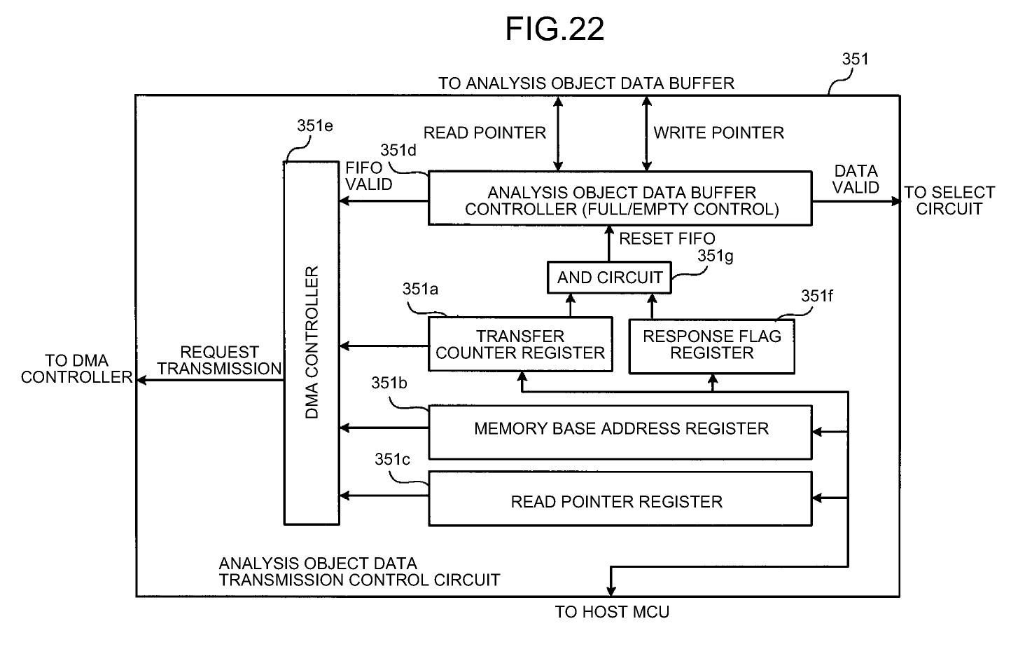

FIG. 22 is a block diagram illustrating an internal configuration of the analysis object data transmission control circuit according to the second embodiment. In FIG. 22, elements except for the response flag register 351f and an AND circuit 351g have the same functions as those of the elements having the same names in the analysis object data transmission control circuit 331 according to the first embodiment illustrated in FIG. 12.

The response flag register 351f is connected to the host MCU 123, so that a response flag is set thereto by the host MCU 123. A value of the transfer counter register 351a and a value of the response flag register 351f are input to the AND circuit 351g. When values other than 0 are set to the transfer counter register 351a and the response flag register 351f, the AND circuit 351g outputs a signal instructing to reset the analysis object data buffer 332 having the FIFO scheme, to an analysis object data buffer controller 351d.

When an error exists in the command process, basic error information in the response data is transmitted, and additional error information can be transmitted as the analysis object data by using a non-transmission time interval between consecutively transmitted response data.

In the management terminal 200, a procedure of a process of extracting the analysis object data from trace data is the same as the procedure according to the first embodiment illustrated in FIG. 15. However, when the analysis object data is extracted by the management terminal 200, if the header 91a in “ALL ZERO” (refer to FIG. 17) following the EOF primitive of the response data is detected, it is determined that the data is the analysis object data 91.

In a third embodiment, scrambling is applied to analysis object data. In the first and second embodiments, the analysis object data are actively output from the storage apparatus 100. In other words, even when there is no external request, if a predetermined event (updating of internal information or occurrence of error) exists, the storage apparatus 100 output the analysis object data. The analysis object data are information on performance or quality of the storage apparatus 100. The analysis object data also has internal information that needs to be disclosed to a third party. Therefore, in the third embodiment, the scrambling is applied to the analysis object data, so that the contents of the analysis object data cannot be understood by entities other than the management terminal 200.

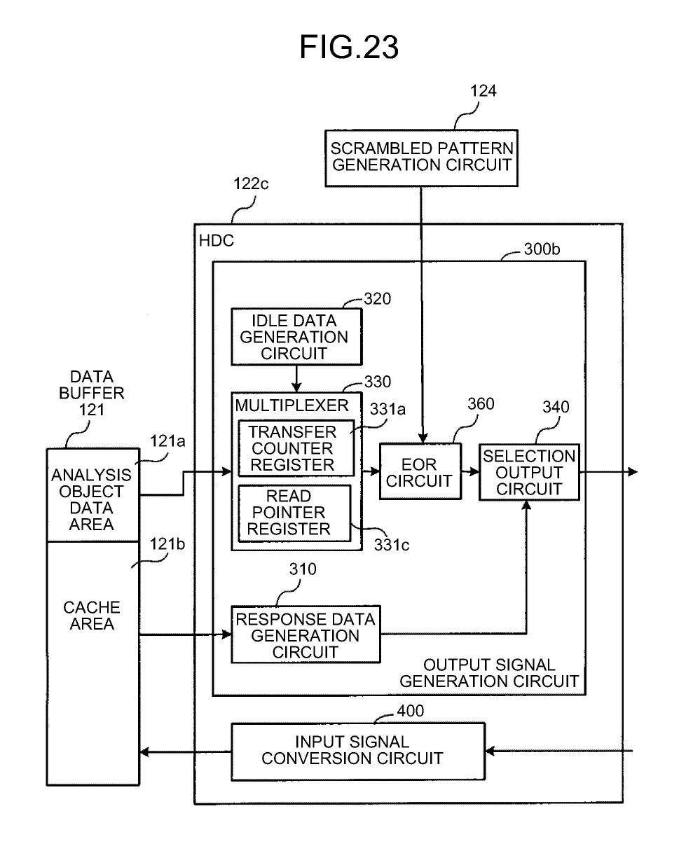

FIG. 23 is a block diagram illustrating a configuration of an HDC 122c according to the third embodiment. In the internal configuration of the HDC 122c according to the third embodiment, only an EOR (exclusive OR) 360 of the output signal generation circuit 300b is different from the configuration of the first embodiment illustrated in FIG. 7. Therefore, the same function elements as those of the first embodiment are denoted by the same reference numerals of FIG. 7, and description thereof is omitted.

In the third embodiment, a scrambled pattern generation circuit 124 is installed in the interface controller 120 of the storage apparatus 100. The scrambled pattern generation circuit 124 is a circuit that generates a predetermined random number sequence.

An output signal of the multiplexer 330 is input to the EOR circuit 360 in the output signal generation circuit 300b. A scrambled pattern that is generated by the scrambled pattern generation circuit 124 is input to the EOR circuit 360. The EOR circuit 360 outputs an exclusive OR of the output signal of the multiplexer 330 and the scrambled pattern to the selection output circuit 340.

In this manner, the scrambling can be applied to the analysis object data. The management terminal 200 descrambles the analysis object data acquired from the bus trace according to a predetermined scrambled pattern. Accordingly, only the management terminal 200 can refer to the contents of the analysis object data. In other words, since the analysis object data cannot be decoded without knowing the scrambled pattern, the original data cannot be known to a third party.

In the configuration of the example of FIG. 23, the scrambled pattern generation circuit 124 and the EOR circuit 360 are added to the configuration of the first embodiment. Similarly, in a configuration where the scrambled pattern generation circuit 124 and the EOR circuit 360 are added to the configuration of the second embodiment illustrated in FIG. 19, the analysis object data can be scrambled.

As described above, according to the first to third embodiments, by transmitting valid data to the interface, the internal information of the device can be acquired by using a commercially available bus trace apparatus. In addition, since only the analysis object data instead of the idle data can be transmitted, the operations of the interface are not influenced, and the operations of the system are not influenced. In addition, since the operations of the host MCU need not be stopped due to the firmware of the storage apparatus 100, the internal information of the device can be acquired during the operation of the system.

That is to say, according to any one of the aforementioned embodiments, the storage apparatus and the apparatus assembled with the output signal generation circuit can output the analysis object data through the communication interface during the time which the data communication through the communication interface continues to be performed.

In addition, a specific command needs not to be issued from the host computer 30. Therefore, the internal information of the device can be acquired without performing manipulation from the host computer 30.

The analysis object data can be checked in real time.

Although the hard disk drive is exemplified as the storage apparatus 100 in the first to third embodiments, the invention can be adapted to a tape device or various secondary memory devices such as a semiconductor memory.

The processing functions of the management terminal 200 can be implemented by a computer. In this case, a program describing contents of the processing functions of the management terminal 200 is provided. The computer executes the program, so that the processing functions are implemented in the computer. The program describing the contents of the processing functions can be recorded on a computer-readable recording medium. As the computer-readable recording medium, there is a magnetic storage device, an optical disk, a magneto-optical recording medium, a semiconductor memory, or the like. As the magnetic storage device, there is a hard disk drive (HDD), a flexible disk (FD), a magnetic tape, or the like. As the optical disk, there is a DVD (Digital Versatile disc), a DVD-RAM, a CD-ROM (Compact disc Read Only Memory), a CD-R (Recordable), a CD/RW (Rewritable), or the like. As the magneto-optical recording medium, there is a MO (Magneto-Optical disc) or the like.

When the program is distributed, for example, a portable recording medium such as a DVD and a CD-ROM, on which the program is recorded, is provided for sale. In addition, the program may be stored in a storage apparatus of a server computer, and the program may be transmitted from the server computer to another computer via a network.

The computer that executes the program stores the program recorded on the portable recording medium or the program transmitted from the server computer in the storage apparatus thereof. In addition, the computer reads the program from the storage apparatus thereof and executes processes according to the program. In addition, the computer may directly read the program from the portable recording medium and execute the processes according to the program. In addition, the computer may sequentially execute the processes according to the program downloaded every time when the program is transmitted from the server computer.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage apparatus configured to connect to other apparatus through a communication interface, comprising:
a memory device;
an analysis object data writing module configured to write, when a predetermined event occurs, analysis object data corresponding to the event in the memory device;
a response data generator configured to generate response data corresponding to a request input through the communication interface; and
a data output module configured to output the response data through the communication interface when the response data exist, and output the analysis object data stored in the memory device through the communication interface by using a non-transmission time interval of the response data.

2. The storage apparatus of claim 1, wherein the data output module outputs the analysis object data when the response data to be transmitted does not exist.

3. The storage apparatus of claim 2, wherein the data output module outputs idle data having a predetermined data pattern when the response data to be transmitted and the analysis object data do not exist.

4. The storage apparatus of claim 1, wherein, when a plurality of the response data are consecutively transmitted, the data output module outputs the analysis object data in the non-transmission time interval of the response data from when the transmission of the former response data is ended until when the transmission of the latter response data is started.

5. The storage apparatus of claim 4, wherein, when the analysis object data to be transmitted does not exist, the data output module outputs idle data having a predetermined data pattern in the non-transmission time interval of the response data.

6. The storage apparatus of claim 5, wherein the analysis object data includes a header with all bits being 0 or a header with all bits being 1, and the idle data has a data pattern with a mixture of a bit being 0 and a bit being 1.

7. The storage apparatus of claim 1, wherein the data output module scrambles the analysis object data, and outputs the scrambled analysis object data.

8. The storage apparatus according to claim 1, wherein, when a command error occurs with respect to the request input through the communication interface, the analysis object data writing module writes additional error information including detailed information not included in basic error information responding to the request, as the analysis object data, in the memory device.

9. An output signal generation circuit configured to generate an output signal to be transmitted through a communication interface, comprising:
a response data generator configured to generate a response data corresponding to a request input through the communication interface; and
a data output module configured to output the response data through the communication interface when the response data exists, and output analysis object data generated according to occurrence of a predetermined event through the communication interface by using a non-transmission time interval of the response data.
